(19) United States
(12) Patent Application Publication
(10) Pub. No.: US 2009/0148769 A1
(43) Pub. Date: Jun. 11, 2009

(54) DENDRITE-FREE LITHIUM ELECTRODE AND METHOD OF MAKING THE SAME

(75) Inventors: Oleg Volkov, Fishers, IN (US); Peter Novak, Ft. Lauderdale, FL (US); Alexander Mordukhaevich Skundin, Moscow (RU); Tatiana L'vovna Kulova, Moscow (RU); Oxana Yurievna Griegorieva, Moscow (RU)

Correspondence Address: HOWARD & HOWARD ATTORNEYS PLLC, 450 West Fourth Street, Royal Oak, MI, 48067, US

(73) Assignee: ENER1, INC., Ft. Lauderdale, FL (US)

(21) Appl. No.: 11/951,944

(22) Filed: Dec. 6, 2007

(51) Int. Cl. H01M 4/00; H01M 10/36; B32B 38/00

(52) U.S. Cl. 429/209; 156/281; 156/64

(57) ABSTRACT

The present invention provides a method of modifying a surface of a lithium electrode, e.g. a negative lithium electrode, for a battery cell. The method comprises the step of applying a thin layer of a carbonaceous material onto the surface of the lithium electrode. The method further comprises the step of applying a pressure to the thin layer and to the surface to promote tight contact between the surface and the thin layer. The method further comprises the step of storing the thin layer and the lithium electrode in an atmosphere comprising carbon dioxide (CO₂) gas for a period of time sufficient to significantly lithiate carbon of the carbonaceous material into an intercalation compound having the formula LiₓC₆. A battery cell, e.g. a secondary (rechargeable) battery cell, comprises the lithium electrode made by the method of the present invention.

### FIELD OF THE INVENTION

The present invention generally relates to a lithium electrode comprising a carbonaceous material and lithium, and more specifically to a lithium electrode having a thin layer capable of transmitting lithium (Li) ions made in an atmosphere comprising carbon dioxide gas, and to a battery cell and to a method of making the same.

### DESCRIPTION OF THE RELATED ART

Modern development of various electronic devices, including portable personal computers, cellular phones, video cameras, etc. demand creating smaller and lighter secondary (rechargeable) batteries than traditional secondary batteries. It is often desired to have secondary batteries with high energy density, long service-life, and high cycle-life. It is also desired to have secondary batteries with load-leveling. Such secondary batteries are also needed for further development of electric and hybrid vehicles. Often, it is very desirable and attractive to use substances with high specific capacity, alkali metals being among such substances. For example, specific capacity of lithium, namely 1 F per 7 g, i.e., 3.829 Ah/g, is much more than that of lead, namely 2 F per 207 g, i.e., 0.26 Ah/g.

Unfortunately, development of secondary batteries employing lithium negative electrodes has met serious problems. Specifically, when lithium metal alone is used in the negative electrode of the battery, during charging, dendrites (crystals in the shape of tree branches) are generated on the surface of the lithium metal. The dendrites penetrate through a separator in the battery, and contact a positive electrode in the battery, which creates short-circuiting. In a best case scenario, short-circuiting results in energy loss and battery heating, but in a worst case scenario, short-circuiting can cause a fire or an explosion.

Another problem connected with formation of dendrites is so-called “encapsulating”. During deposition and growth of the highly branched dendrites, surfaces of the dendrites interact with components of an electrolyte in the battery, which can include impurities, e.g. water traces, etc. As a result of encapsulating due to the interaction, an insulating film covers separate dendrites and fully isolates them from the lithium electrode. Thus, during every charge-discharge cycle of the battery, formation and encapsulating of dendrites lessens a functional amount of the lithium metal, which, over time, corresponds to capacity fading of the battery.

During the last three decades, there have been attempts to solve the aforementioned problems of dendrite formation and encapsulating. For example, it has been found that very small additives, specifically, trace additives of hydrogen fluoride in propylene carbonate electrolyte provide a lithium deposition in the form of a fine-grain layer instead of dendrites. This is described in the papers of K. Kanamura, S. Shiraishi, H. Tamura, and Z. Takehara, J. Electrochem. Soc., 1994, vol. 141, page 2379; and K. Kanamura, S. Shiraishi, and Z. Takehara, J. Electrochem. Soc., 1996, vol. 143, page 2187.

As another example, favourable effects of carbon dioxide (CO₂) in an electrolyte on suppression of dendrite formation are described in the following papers: Y. Malik, D. Aurbach, P. Dan, and Meitav, J. Electroanalyt. Chem., 1990, vol. 282, page 73; D. Aurbach, Y. Grofer, M. Ben-Zion, P. Aped, J. Electroanalyt. Chem., 1992, vol. 339, page 451; D. Aurbach and A. Zaban, J. Electroanalyt. Chem., 1993, vol. 348, page 155; D. Aurbach and A. Zaban, J. Electroanalyt. Chem., 1984, vol. 365, page 41; and T. Osaka, T. Momma, T. Tajima, and Y. Matsuda, J. Electrochem. Soc., 1995, vol. 142, page 1057.

Moreover, one can find in the scientific literature a special electrolyte formulation for preventing dendrite formation. An example of such a formulation is a LiAsF₆ solution in 1,3-dioxolane with an additive of tributylamine, which is described in the following papers: D. Aurbach, Y. Grofer, and M. Ben-Zion, J. Power Sources, 1992, vol. 39, page 163; D. Aurbach and M. Moshkovich, J. Electrochem. Soc., 1998, vol. 145, page 2629; and D. Aurbach, E. Zinigrad, H. Teller, and P. Dan, J. Electrochem. Soc., 2000, vol. 147, page 1274.

Another way to overcome dendrite formation consists in using lithium alloys instead of plain lithium metal, for example, low-percentage lithium alloys such as Li—Al, Li—Pb—Bi—Sn, etc. However, these lithium alloys suffer from a large change of their specific volume in the course of charge-discharge cycles. The large change results in cracking and crushing of the electrodes during cycling and sharp increase of the ohmic resistance of the electrodes. More attractive lithium alloys are disclosed in U.S. Pat. No. 5,498,495. These alloys can be ternary, namely Li:Ag:Te, or can be multi-component, namely, Li:Ag:Te:M1:M2, wherein M1 is selected from the group consisting of Al, Si, In, and M2 is selected from the group consisting of Zn, Fe, Co, Ni, Mn, Mo, and W.

Another way to solve the problems of dendrite formation and encapsulating consists in covering the surface of the lithium electrode with a coating. These coatings often possess the properties of a solid electrolyte. In these cases, the discharge of Li⁺ ions takes place underneath the coating, thus, dendrite formation and growth are generally avoided. Examples of such coatings are described in U.S. Pat. Nos. 5,824,434 (the '434 patent) and 6,207,326 (the '326 patent). According to these patents, a surface of a negative electrode is covered with a film having a structure which allows ions relating to the battery reactions to pass through. According to the '434 patent, the aforementioned film must be: (1) a multi-layered metal oxide film, the metal oxide being Al₂O₃, TiO₂, SiO₂, SeO₃, ZrO₂, MgO, Cr₂O₃, CaO, SnO, In₂O₃, or GeO₂, or (2) a multi-layered metal oxide film as a composite of an organic polymer. According to the '326 patent, the aforementioned film contains nitrogen atoms or halogen atoms and the concentration of those are gradually lowered from the surface to the inside portion of the negative electrode. The '434 and '326 patents describe examples of other films, which include films having inorganic glass structure; polymer films of derivative of aromatic hydrocarbon compounds; polymer (polyphosphazene) films in whose phosphor atoms and nitrogen atoms are alternately bonded in a phosphate-nitrogen double bond manner; etc. Unfortunately, the '434 and '326 patents don't adequately explain a mechanism of protecting action of the film, i.e. the mechanism of dendrite suppression.

As an alternative to secondary batteries with negative electrodes made from plain lithium, novel types of secondary batteries were developed, namely lithium-ion batteries. Lithium-ion batteries are free from the problems of dendrite formation and encapsulating, but their energy density is inevitably less than potential energy density of pure lithium batteries. For example, specific capacity of carbon (graphite) negative electrodes in lithium-ion batteries, are generally not more that ˜0.37 Ah/g.

Accordingly, there remains an opportunity to provide methods of preventing/suppressing, if not stopping, dendrite formation. As such, there also remains an opportunity to provide methods of preventing/suppressing, if not stopping, dendrite encapsulating. There also remains an opportunity to provide improved lithium electrodes and battery cells employing such lithium electrodes.

### SUMMARY OF THE INVENTION AND ADVANTAGES

The present invention provides a method of modifying a surface of a lithium electrode for a battery cell. The method comprises the step of applying a thin layer of a carbonaceous material onto the surface of the lithium electrode. The method further comprises the step of applying a pressure to the thin layer and to the surface to promote tight contact between the surface and the thin layer. The method further comprises the step of storing the thin layer and the lithium electrode in an atmosphere comprising carbon dioxide (CO₂) gas for a period of time sufficient to significantly lithiate carbon of the carbonaceous material into an intercalation compound having the formula LiₓC₆. A battery cell comprises the lithium electrode made by the method of the present invention.

The present invention provides a method of modifying the lithium electrode, e.g. a negative lithium electrode, which can be used to make battery cells, such as secondary battery cells. The battery cells of the present invention generally have little to no fade over many charge-discharge cycles. Dendrite formation and encapsulation is greatly reduced, if not eliminated, over many charge-discharge cycles.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a graph depicting cycling history of a battery cell of the present invention; and

FIG. 2 is a graph depicting cycling history of a comparative battery cell.

### DETAILED DESCRIPTION OF THE INVENTION

The present invention provides a method of modifying a surface of a lithium electrode for a battery cell. The lithium electrode is typically employed as a negative lithium electrode. As such, the lithium electrode will hereinafter be referred to as the negative lithium electrode. The negative lithium electrode can be used for assembling a battery cell, typically a secondary (rechargeable) battery cell, with, for example, a positive electrode. The negative lithium electrode, and therefore the battery cell, can be stored in a dry condition or it can be wetted by an electrolyte, e.g. a non-aqueous electrolyte, all of which is further described below.

The method comprises the step of applying a thin layer of a carbonaceous material onto the surface of the negative lithium electrode. The carbonaceous material can comprise various carbon based materials known the art. In certain embodiments, the carbonaceous material is selected from natural graphite, artificial graphite, or combinations thereof. Suitable examples of other carbonaceous materials, for purposes of the present invention, are natural and artificial graphites, partially graphitized or amorphous carbon, petroleum coke, needle coke, various mesophases, carbon fibers, etc.

The carbonaceous material can be in a disperse form, such as powders, fibers, flakes, etc. In these embodiments, the negative lithium electrode can be manufactured by any method known in the art, such as by preparing a slurry from a carbonaceous powder and a binder agent, applying the slurry onto/into a current-collector, and drying. If employed, the binder agent can be chosen from such compounds including, but not limited, to, polyvinylidene fluoride (PVDF), ethylene-propylene diene termonomer (EPDM), ethylene vinyl acetate copolymer (EAA), and combinations thereof. Typically, the binder agent is PVDF, if employed

More typically, the carbonaceous material comprises a fibrous carbonaceous material. Examples of suitable fibrous carbonaceous materials, for purposes of the present invention, include, but are not limited to carbon paper, carbon cloth, carbon felt, etc. If employed, the fibrous carbonaceous material is typically a carbon paper. The carbon paper can be made my methods known in the art, such as by paper manufacturing methods known to those skilled in the paper art. Suitable carbonaceous materials are commercially available from a variety of sources known in the art. One specific example of a suitable carbon paper, for purposes of the present invention, is an untreated Toray carbon paper, EC-TP2-060, commercially available from Electrochem. Inc., of Woburn Mass. Typically, the carbon paper has good mechanical strength, rather high porosity, e.g. up to about 82%, high electronic conductivity, and acceptable intercalation capacity, e.g. up to about 320 mAh/g. It is to be appreciated that other carbon papers may also be used. In addition, the negative lithium electrode may include a combination of two or more of the aforementioned carbonaceous materials.

If employed, the fibrous carbonaceous material, e.g. the carbon paper, can be directly applied onto the surface. In other embodiments, the fibrous carbonaceous material can first be disintegrated prior to application, such as by milling, tearing, mortar and pestle, grinding, etc. Generally, the thin layer of the carbonaceous material is as thin as possible. Typically, the thin layer of the carbonaceous material, e.g. the carbon paper, has a thickness ranging from about 0.1 to about 1000, more typically from about 1 to about 100μ. The thin layer is typically of uniform thickness. Further, the thin layer is typically intact, i.e., the thin layer generally does not have holes, defects, or other imperfections. It is believed that such holes, defects, or imperfections can allow dendrite formation on the surface. It is to be appreciated that the thin layer may also be referred to as a film.

The negative lithium electrode, prior to applying the carbonaceous material, can be made by various methods known to those skilled in the art. For example, the negative lithium electrode can be manufactured from a piece of lithium metal pressed onto a suitable current collector. The piece of lithium metal can be in various forms. For example, the piece of lithium metal can be in the form of, but is not limited to, blocks, wire, strips, plates, foils, etc. Typically, the piece of lithium metal is a foil. The current collector can be made from metals and/or alloys, including, but not limited to, nickel, titanium, stainless steel, aluminium, copper, etc. The current collector can be manufactured into various forms, such as a sheet, a strip, a foil, a mesh, a net, a foamed metal plate, etc. The foil can be of various thicknesses, typically having a thickness ranging from about 10 to about 1000μ. Typically, the positive electrode is an electrode using oxides of transition metals, more typically using vanadium oxides with the formula VₓO_{y}, wherein x and y are typically positive integers, and y=2*x+1. Other vanadium oxides include vanadium(II) oxide, vanadium(III) oxide, and vanadium(IV) oxide. It is to be appreciated that various vanadium oxides and phases thereof as known to those skilled in the art may be used.

If employed, the positive electrode can be manufactured by various methods known in the art. The positive electrode generally comprises the active material, as described and exemplified above, a conductive material, and a binder, applied onto/into a proper current collector. The aforementioned current collector can be made from metals and/or alloys, including, but not limited to, nickel, titanium, stainless steel, aluminium, and copper, with the latter generally being preferred. The current collector can be manufactured into various forms, such as a sheet, a strip, a foil, a mesh, a net, a foamed metal plate, etc. In certain embodiments, the positive electrode typically comprises about 100 parts by weight of a V₆O₁₃ powder. In these embodiments, the positive electrode further comprises from about 1 to about 30 parts by weight of the conductive additive and from about 1 to about 20 parts of the binder. Various types of binders known in the art can be used. Typically, the binder is the same one as used to make the negative electrode, such as, but not limited to PVDF. In certain embodiments, the binder comprises a solution of PVDF in a solvent such as N-methyl-2-pyrrolidone, acetone, another ketone known to those skilled in the art, and combinations thereof. The lithium-ion battery cell can be made by various methods known in the art.

Typically, the battery cell further comprises a separator, as understood to those skilled in the art. Various types of separators known in the art can be used for purposes of the present invention. The separator can be manufactured by various methods known in the art. It is to be appreciated that the present invention is not limited to any particular method of making the battery cell.

The method further comprises the step of applying a pressure to the thin layer and to the surface of the negative lithium electrode to promote tight contact between the surface and the thin layer. In other words, the thin layer of the carbonaceous material is typically pressed, more typically tightly pressed, onto the surface of the negative lithium electrode. The pressure applied typically ranges from about 1 to about 10 MPa, more typically from about 2 to about 5 MPa. If the carbonaceous material is the carbon paper or includes the carbon paper, the negative lithium electrode is generally made by pressing the carbon paper to the negative lithium electrode with a magnitude of pressure insufficient to damage the carbon paper. In other words, the pressure is such that the carbon paper is not mechanically destroyed or degraded, such as by cracking, crushing, pin-holing, etc. It is to be appreciated that such pressure depends upon, for example, yield strength of the carbon paper. A variety of devices can be used to apply the pressure. Such devices include, but are not limited to, mechanical presses, hydraulic presses, rollers, vices, etc. The magnitude of pressure is generally high; however, as described above, if the carbon paper is employed, the pressure should be of a magnitude as to not damage the carbon paper. Typically, it is preferred that distribution of the pressure, during application of the thin layer, is as uniform as possible.

Without being bound or limited to any particular theory, it is believed that some carbonaceous materials being brought into a tight contact with the surface of negative lithium electrode undergo lithium intercalation. It is believed that this process is very close to lithium intercalation that takes place during charge of a negative electrode in a lithium-ion battery. It is believed that the rate and depth of such a “contact intercalation”, strongly depends on, for example, the nature of the carbonaceous material employed.

The method further comprises the step of storing the thin layer and the negative lithium electrode in an atmosphere comprising carbon dioxide (CO₂) gas for a period of time sufficient to significantly lithiate carbon of the carbonaceous material into an intercalation compound having the formula LiₓC₆. Typically, the period of time is sufficient to completely lithiate carbon of the carbonaceous material into the intercalation compound having the formula LiₓC₆. In the aforementioned formulas, subscript x of the intercalation compound typically ranges from about 0.1 to about 1, more typically 0.1<x≦1, most typically x=1. It is to be appreciated that storage of the thin layer and the negative lithium electrode can occur during and/or after application of the thin layer onto the negative lithium electrode. Without being bound or limited to any particular theory, it is believed that the intercalation compound, e.g. a thin protective layer of the intercalation compound, substantially, if not totally prevents/suppresses dendrite formation and/or dendrite growth because the intercalation compound prevents a direct contact of the negative lithium electrode and an electrolyte, which is described below. It is believed that this is especially important during charge-discharge cycling of the negative lithium electrode in the electrolyte.

The atmosphere can be established and maintained by various methods, such as in a box, directly in a battery cell during manufacture, and/or by other methods known to those skilled in the art. In one embodiment, the atmosphere is plain CO₂ gas, as understood in the art. In other embodiments, the atmosphere further comprises a noble gas. The noble gas can comprise two or more noble gases, e.g. helium (He), neon (Ne), argon (Ar), krypton (Kr), xenon (Xe), radon (Rn), and combinations thereof. In one embodiment, the noble gas is further defined as Ar gas. If the atmosphere comprises the CO₂ gas and the noble gas, e.g. Ar gas, the CO₂ gas is typically present in the atmosphere in an amount no less than 10%, more typically the CO₂ gas is present in the atmosphere in an amount ranging from 10 to about 100%, on a volume basis. In the aforementioned embodiments, the noble gas typically makes up the remainder of the atmosphere. However, the atmosphere may contain trace amounts of other compounds or impurities, for example oxygen gas and/or water vapor. If the atmosphere contains such impurities, the impurities are preferably kept at a minimum, such as 10 ppm or less, to prevent contamination or interference during lithiation of the carbonaceous material.

After applying, e.g. pressing, the thin layer of the carbonaceous material and the negative lithium electrode in the atmosphere together, the thin layer of the carbonaceous material and the negative lithium electrode are stored in the atmosphere for a period of time. The period of time is sufficient to substantially lithiate, more typically completely lithiate carbon of the carbonaceous material. Typically, the period of time ranges from about 10 minutes to about 1 month, more typically from about 12 to about 30 hours, most typically about 24 hours. It is to be appreciated that the period of time can depend on many variables, such as nature of the carbonaceous material, thickness of the thin layer, pressing conditions, etc.

The period of time sufficient to significantly lithiate, more typically completely lithiate carbon of the carbonaceous material is generally determined by observing a color transition of the carbonaceous material. Generally, in the course of interaction between the carbonaceous material, e.g. graphite, and lithium, i.e., in the course of lithium intercalation, the following transformations generally occur: C→LiC₇₂→LiC₃₆→LiC₂₇→LiC₁₈→LiCl₂→LiC₆. Color of carbon of the carbonaceous material, generally changes in the following sequence: black-violet-blue-bright blue-golden-yellow. It is appearance of golden-yellow color that is a sign of lithiating completion, i.e., the color transition becomes a golden-yellow in color when carbon of the carbonaceous material is completely lithiated.

The present invention further provides a battery cell. The battery cell comprises the lithium electrode, i.e., the negative lithium electrode, being modified by the method of the present invention, as described and exemplified herein. Typically, the battery cell is a secondary (rechargeable) battery cell, as understood in the art. The battery cell can be of various sizes, shapes, and configurations. One or more of the battery cells can be used to make secondary batteries of various sizes, shapes, and configurations.

As alluded to above, the battery cell typically further comprises an electrolyte, typically a non-aqueous electrolyte. The non-aqueous electrolyte can be any type of non-aqueous electrolyte known in the art. The non-aqueous electrolyte is typically prepared from a lithium salt, which is dissolved in a solvent, typically a non-aqueous solvent and/or an aprotic solvent. Suitable lithium salts and non-aqueous solvents are known in the art. Examples of suitable lithium salts include, but are not limited to, LiClO₄, LiBF₄, LiPF₆, LiAsF₆, LiCF₃SO₃, LiN(CF₃SO₂)₂, LiC(CF₃SO₂)₃, etc. Suitable solvents include, but are not limited to, alkylcarbonates, propylene carbonate (PC), ethylene carbonate butylene carbonate, dimethyl carbonate, diethyl carbonate, ethyl methyl carbonate, cyclic ethers, cyclic esters, glymes, lactones, sulfones, γ-butyrolactone, tetrahydrofuran, dimethoxyethane (DME), e.g. 1,2-dimethoxyethane, 1,2-diethoxyethane, dioxane, dioxolane (DO), sulfolane, methyl formate, etc. It is to be appreciated that the non-aqueous electrolyte can include any combination of the abovementioned lithium salts and solvents. For example, binary or ternary mixtures of the solvents can be used.

The following examples, illustrating the method, lithium electrodes, and battery cells of the present invention, are intended to illustrate and not to limit the invention.

### EXAMPLES

Inventive electrodes, more specifically, lithium electrodes, were prepared. The lithium electrodes were prepared using a lithium foil. Specifically, a piece of the lithium foil with a thickness of about 75μ was rolled onto a current collector made from a nickel foil. Next, a very thin layer of a carbon paper, having a thickness of about 35μ was rolled onto a frontal surface of the lithium electrode, such that a total thickness of the lithium electrode approached 110μ. All of these procedures were carried out in a glove box having an atmosphere comprising carbon dioxide (CO₂) and argon (Ar) gas. The lithium electrodes were each kept in the glove box and the atmosphere for 24 hours. This time was sufficient for almost completely lithiating carbon of the carbon paper. Specifically, the carbon paper became golden-yellow in color, which indicated formation of a LiC₆ intercalation compound.

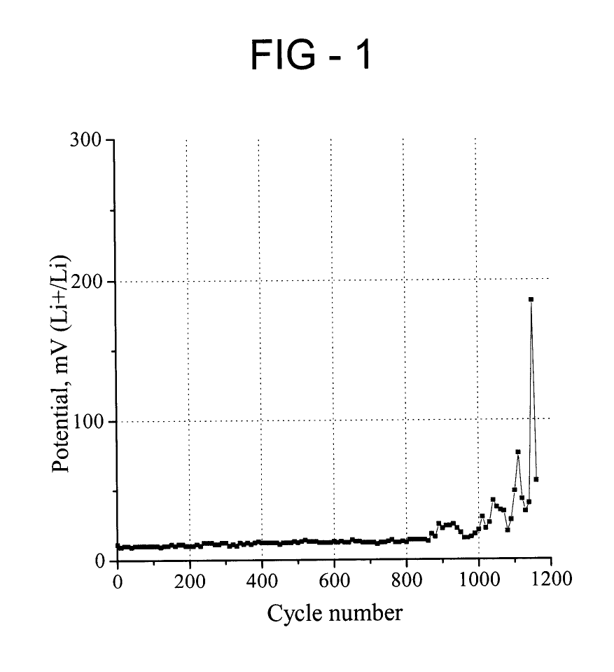

The inventive lithium electrodes were removed from the glove box. An inventive lithium electrode with a protection surface layer of the LiC₆ intercalation compound, i.e., a protected lithium electrode, was tested in an inventive battery cell containing an electrolyte. The electrolyte comprised IM LiN(CF₃SO₂)₂ in dioxolane (DO). The following cycling mode was utilized for testing: 1 mA/cm², for 30 minutes anodic; 1 mA/cm², for 30 minutes cathodic; a final potential (Eₚ)=0.5 V vs Li⁺/Li reference electrode; and a cycling depth=3%. This cycling history of the inventive battery cell is illustrated in FIG. 1. The inventive battery cell withstood more than 1150 cycles. Dendrites appeared on the surface of the inventive lithium electrode surface after about 750 cycles. During the first 880 cycles, anodic over potential did not exceed 20 mV.

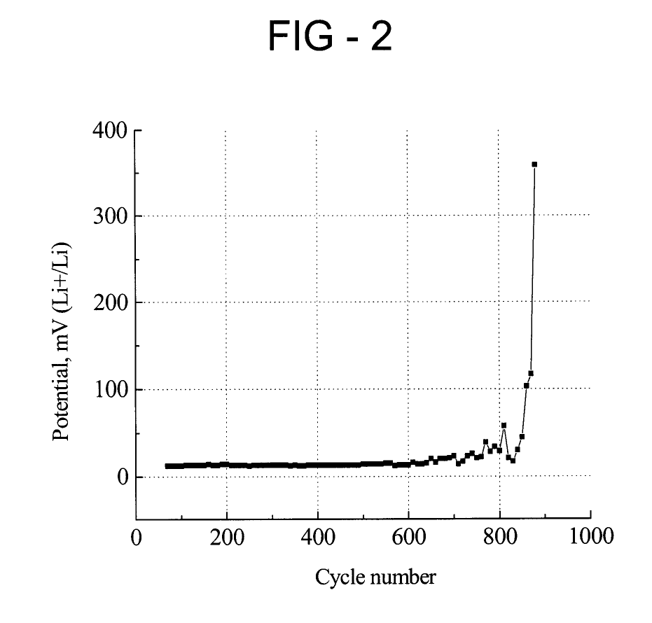

A comparative battery cell was prepared using the same electrolyte as described above. The comparative battery cell contained non-protected lithium electrodes. Both working and counter electrodes in the comparative battery cell were made from a lithium foil rolled onto a nickel current collector. A total thickness of the non-protected lithium electrodes approached 110μ. All procedures were carried out in the same glove box and atmosphere as described above. The same cycling mode as described above was employed for testing. This cycling history of the comparative battery cell is illustrated in FIG. 2. Dendrites appeared on the surface of the non-protected electrode by cycle 17. Comparing FIG. 1 against FIG. 2, other benefits of the present invention can be readily appreciated.

The present invention has been described herein in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described within the scope of the appended claims.

What is claimed is:

1. A method of modifying a surface of a lithium electrode for a secondary battery cell, the method comprising the steps of:
applying a thin layer of a carbonaceous material onto the surface;
applying a pressure to the thin layer and to the surface to promote tight contact between the surface and the thin layer; and
storing the thin layer and the lithium electrode in an atmosphere comprising carbon dioxide (CO₂) gas for a period of time sufficient to significantly lithiate carbon of the carbonaceous material into an intercalation compound having the formula LiₓC₆.

2. A method as set forth in claim 1 wherein subscript x of the intercalation compound ranges from about 0.1 to about 1.

3. A method as set forth in claim 1 wherein the period of time is sufficient to completely lithiate carbon of the carbonaceous material into the intercalation compound having the formula LiₓC₆.

4. A method as set forth in claim 3 wherein subscript x of the intercalation compound ranges from about 0.1 to about 1.

5. A method as set forth in claim 1 wherein the lithium electrode is further defined as a negative lithium electrode.

6. A method as set forth in claim 1 wherein the carbonaceous material comprises a fibrous carbonaceous material.

7. A method as set forth in claim 6 wherein the fibrous carbonaceous material is further defined as a carbon paper.

8. A method as set forth in claim 1 wherein the pressure ranges from about 1 to about 10 MPa.

9. A method as set forth in claim 8 wherein the pressure ranges from about 2 to about 5 MPa.

10. A method as set forth in claim 1 wherein the period of time ranges from about 10 minutes to about 1 month.

11. A method as set forth in claim 10 wherein the period of time ranges from about 12 to about 30 hours.

12. A method as set forth in claim 1 wherein the thin layer has a thickness ranging from about 0.1 to about 1000μ.

13. A method as set forth in claim 12 wherein the thickness ranges from about 1 to about 100μ.

14. A method as set forth in claim 1 wherein the atmosphere further comprises a noble gas.

15. A method as set forth in claim 14 wherein the noble gas is further defined as argon (Ar) gas.

16. A method as set in claim 14 wherein the CO₂ gas is present in the atmosphere in an amount no less than 10%.

17. A method as set forth in claim 14 wherein the CO₂ gas is present in the atmosphere in an amount ranging from 10 to about 100%.

18. A method as set forth in claim 1 wherein the period of time sufficient to significantly lithiate carbon of carbonaceous material is determined by observing a color transition of the carbonaceous material.

19. A method as set forth in claim 18 wherein the color transition becomes a golden-yellow in color when carbon of the carbonaceous material is completely lithiated.

20. A battery cell comprising:
a lithium electrode having a surface, said surface being modified by applying a thin layer of a carbonaceous material onto said surface;
applying a pressure to said thin layer and to said surface to promote tight contact between said surface and said thin layer; and
storing said thin layer and said lithium electrode in an atmosphere comprising carbon dioxide (CO₂) gas for a period of time sufficient to significantly lithiate carbon of said carbonaceous material into an intercalation compound having the formula LiₓC₆.

21. A battery cell as set forth in claim 20 further comprising a non-aqueous electrolyte.

22. A battery cell as set forth in claim 20 wherein said lithium electrode is further defined as a negative lithium electrode.

23. A battery cell as set forth in claim 20 wherein subscript x of said intercalation compound ranges from about 0.1 to about 1.

24. A battery cell as set forth in claim 20 wherein the period of time is sufficient to completely lithiate carbon of said carbonaceous material into said intercalation compound having the formula LiₓC₆.

25. A battery cell as set forth in claim 24 wherein subscript x of said intercalation compound ranges from about 0.1 to about 1.

26. A battery cell as set forth in claim 20 further defined as a secondary battery cell.
